(19) United States
(12) Patent Application Publication
(10) Pub. No.: US 2007/0244710 A1
(43) Pub. Date: Oct. 18, 2007

(54) PROVIDING INTERGRATED INVESTIGATION

(76) Inventor: JAMES B. PERSINGER, KINGSTON, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/692,696

(22) Filed: Mar. 28, 2007

Related U.S. Application Data
(60) Provisional application No. 60/786,531, filed on Mar. 28, 2006.

(51) Int. Cl. G06Q 10/00; G06Q 30/00

(52) U.S. Cl. 705/1

(57) ABSTRACT

Included are embodiments for providing an integrated investigation. At least one embodiment includes a method that includes receiving data associated with an investigation case and organizing the received data according to the determined data type. Additionally, at least one embodiment includes providing an interactive interface for creating a case report associated with the received data, the interactive interface configured to incorporate at least one module for receiving data from a remote data capture device.

### CROSS REFERENCE

This application claims the benefit of U.S. Provisional Application No. 60/786,531, filed Mar. 28, 2006, which is hereby incorporated by reference in its entirety.

### BACKGROUND

During the normal day-to-day operations surrounding the gathering of information related to an investigation case, an investigator may be assigned the task of collecting video, images, and reports. Once this task is complete, the investigator is often faced with preparing the case file for client's review.

Currently, in order to perform this task, the investigator compiles and edits video, images, and/or reports onto a Video Home system (VHS) tape, Digital Video Disc (DVD) and/or other portable storage medium. Once this is complete, the investigator then creates a label and places the label on the storage medium to identify the data contained therein. The investigator may then provide the data to the client.

Similarly, another current technique must utilize a plurality of software applications to create, edit, or modify the files (video, images, and reports). In such a configuration, the investigator manually places material for the case on a network or local hard drive. The investigator must then decide to burn or copy the information to a floppy disk, CD-ROM, DVD, and/or other portable storage medium. On the client side, there may also be difficulties associated with the current techniques. As a nonlimiting example, when the portable storage medium is inserted into a computer (and/or other device configured to read data from the portable storage medium), the client must navigate the directories on that portable storage medium to access the desired information. As such, this may be an inconvenient and/or time-consuming manner in which to view the desired data. Further, once the portable storage medium is created, there may be difficulty in reproducing the data stored on the portable storage medium, if the portable storage medium is lost or damaged.

Thus, a need exists in the industry to address these and other deficiencies and inadequacies.

### SUMMARY

Included are embodiments for providing an integrated investigation. At least one embodiment includes a method that includes receiving data associated with an investigation case and organizing the received data according to the determined data type. Additionally, at least one embodiment includes providing an interactive interface for creating a case report associated with the received data, the interactive interface configured to incorporate at least one module for receiving data from a remote data capture device.

Additionally included are embodiments of a system for providing an integrated investigation. At least one embodiment of a system includes a first receiving component configured to receive data associated with an investigation case and an organizing component configured to organize the received data according to the determined data type. Some embodiments include a providing component configured to provide an interactive interface for creating a case report associated with the received data, the interactive interface configured to incorporate at least one module for receiving data from a remote data capture device.

Also included are embodiments of a computer readable storage medium for providing an integrated investigation. At least one embodiment of a computer readable storage medium includes first receiving logic configured to receive data associated with an investigation case and organizing logic configured to organize the received data according to the determined data type. Some embodiments include providing logic configured to provide an interactive interface for creating a case report associated with the received data, the interactive interface configured to incorporate at least one module for receiving data from a remote data capture device.

Other systems, methods, features, and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

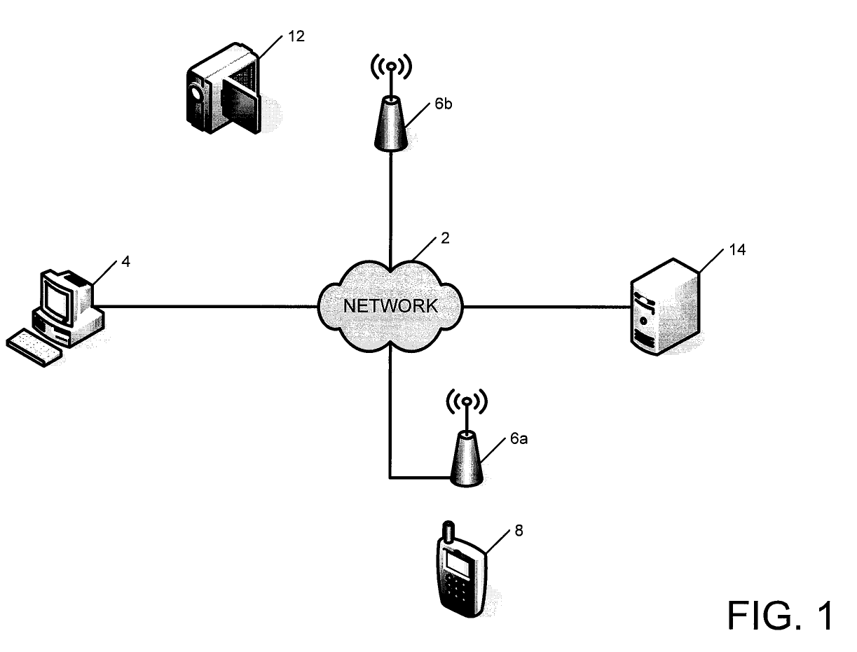

FIG. 1 is an exemplary network configuration, illustrating a plurality of elements that may be utilized in facilitating an integrated investigation.

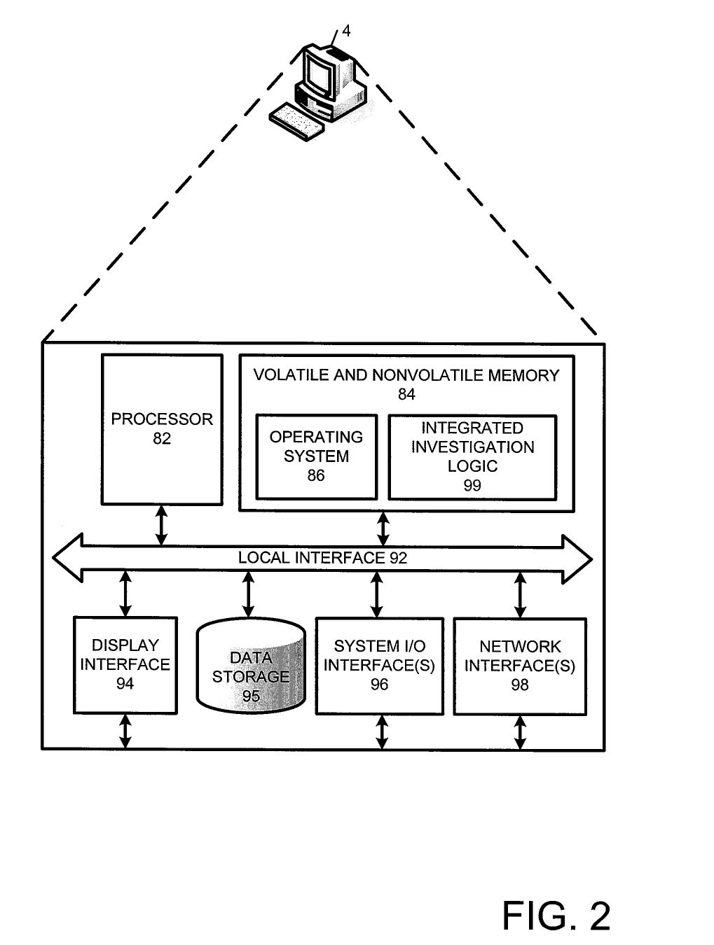

FIG. 2 is an exemplary embodiment of a plurality of components that may be utilized in a computing device, such as the computing device, from FIG. 1.

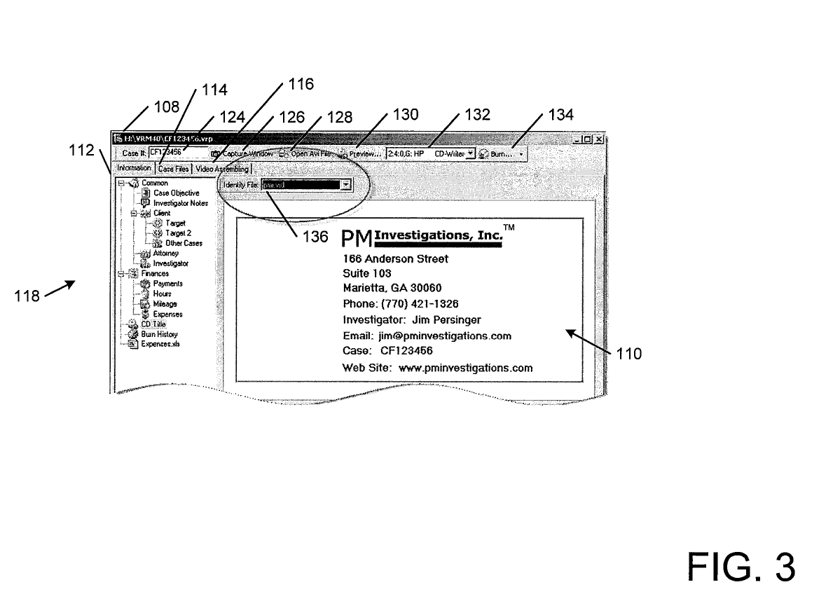

FIG. 3 is an exemplary embodiment of a user interface that may be provided to an investigator in configuring an integrated investigation case, such as described with reference to FIG. 2.

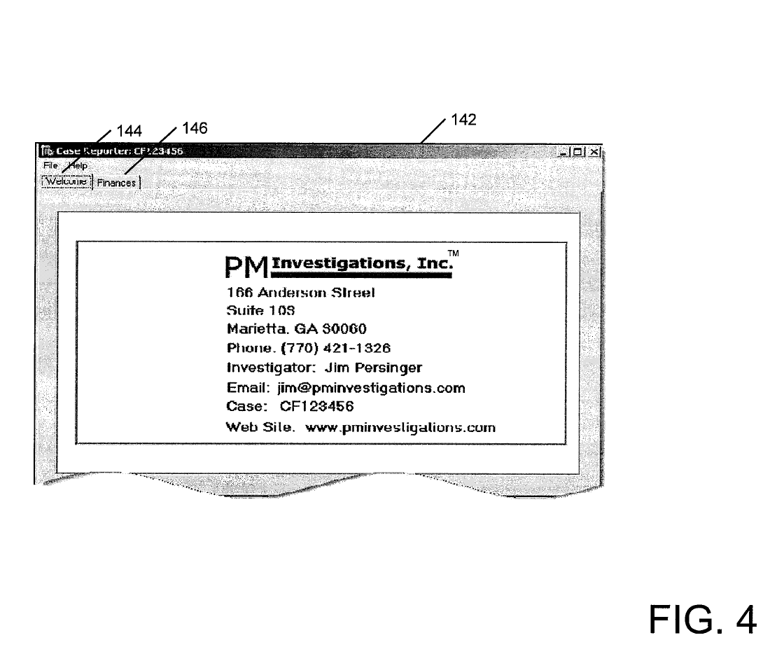

FIG. 4 is an exemplary embodiment of a user interface of client information that may be presented to a client, such as may be created by the integration investigation logic from FIG. 2.

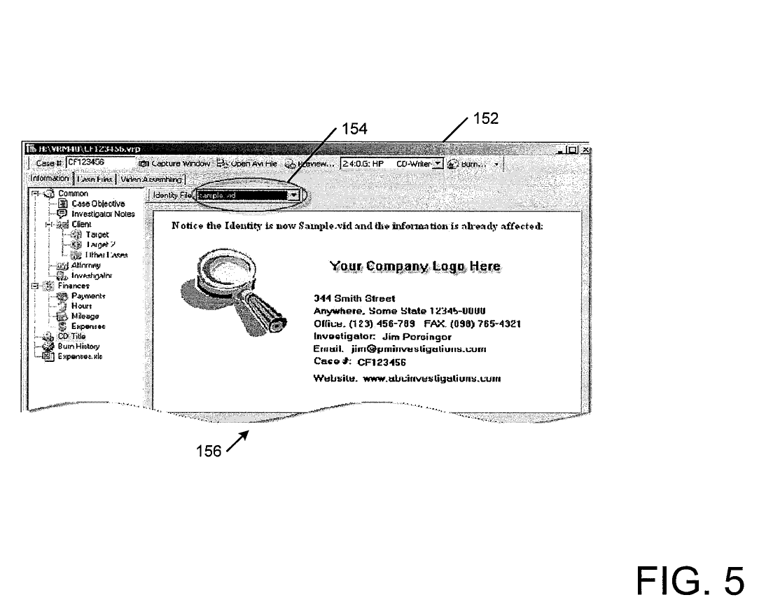

FIG. 5 is an exemplary embodiment of a user interface that includes client data, similar to the interface from FIG. 3.

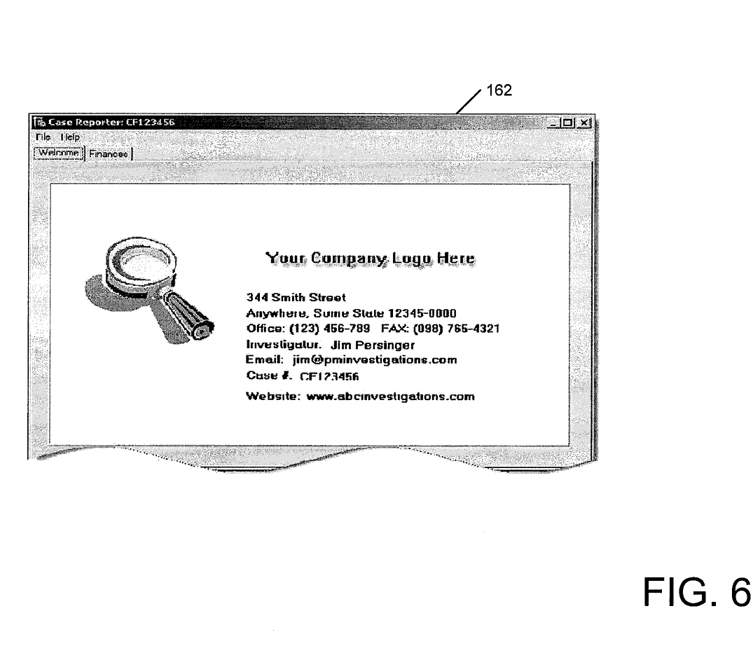

FIG. 6 is an exemplary embodiment of a user interface that includes amended client data, similar to the interface from FIG. 4.

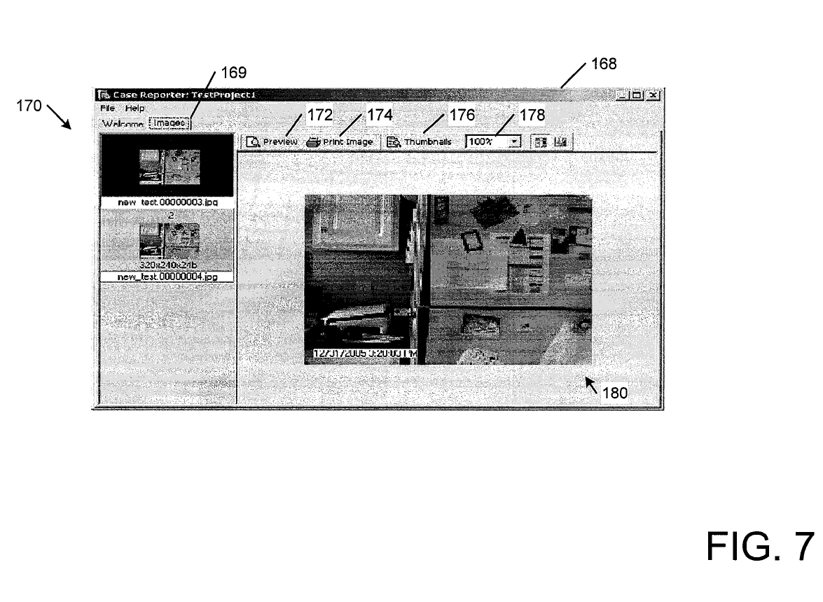

FIG. 7 is an exemplary embodiment of a user interface that includes one or more images associated to a case, similar to the interface from FIG. 6.

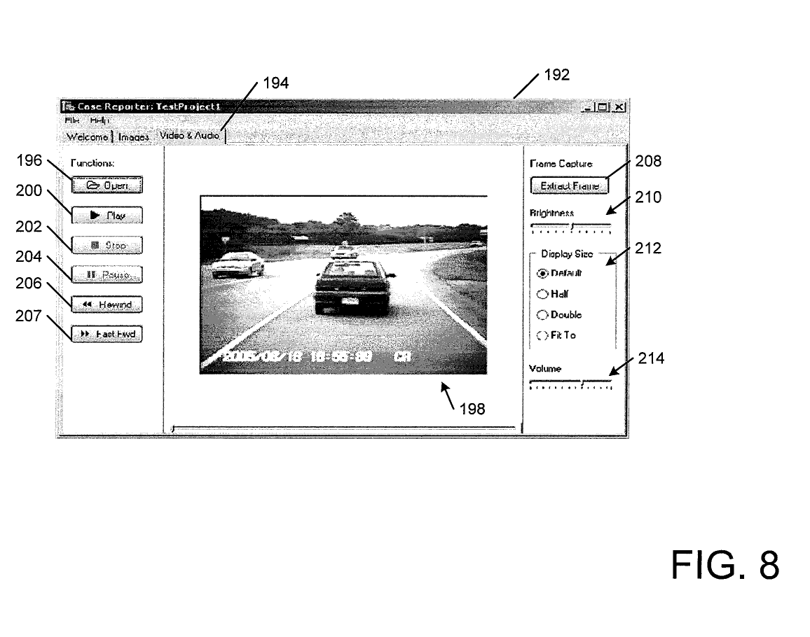

FIG. 8 is an exemplary embodiment of a user interface for displaying video and/or audio, similar to the interface from FIG. 7.

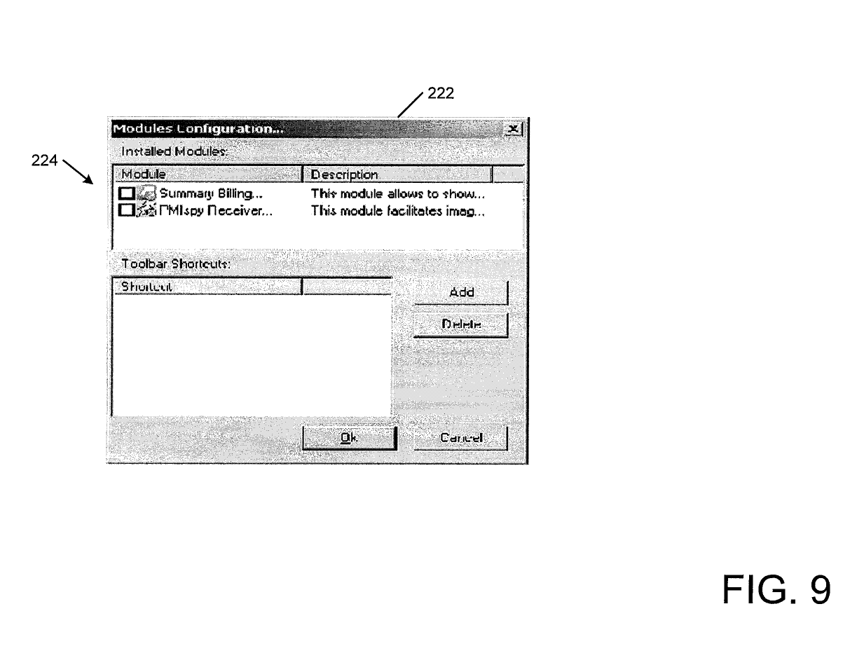

FIG. 9 is an exemplary embodiment of a user interface that may facilitate addition and/or deletion of one or more data capture module from the visual report manager, such as may be provided by the computing device, from FIG. 2.

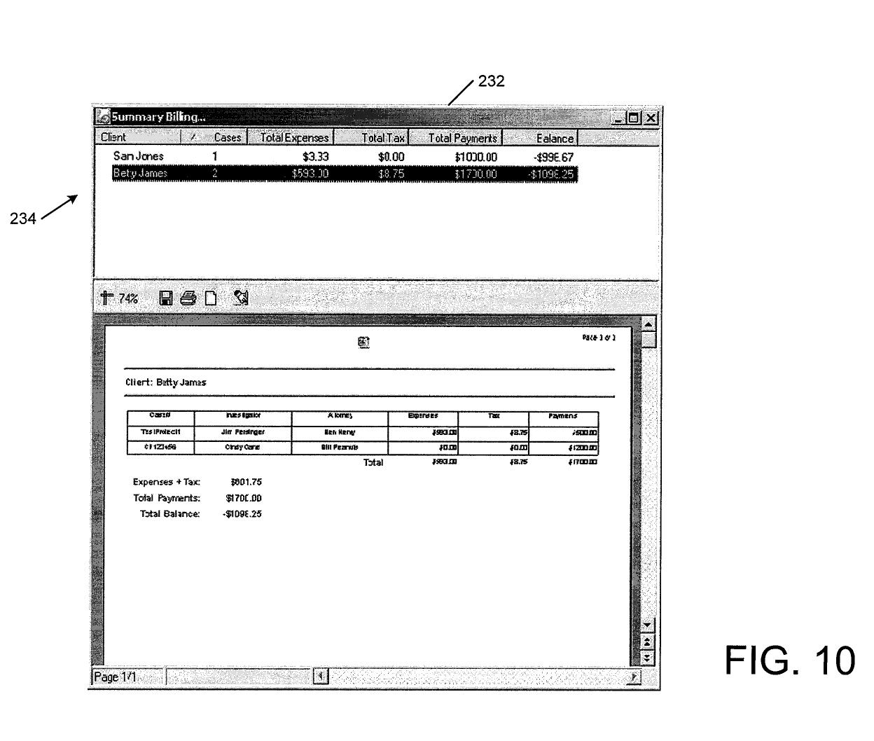

FIG. 10 is an exemplary embodiment of a summary billing user interface 232, which may be accessed via a summary billing module, such as displayed in FIG. 9.

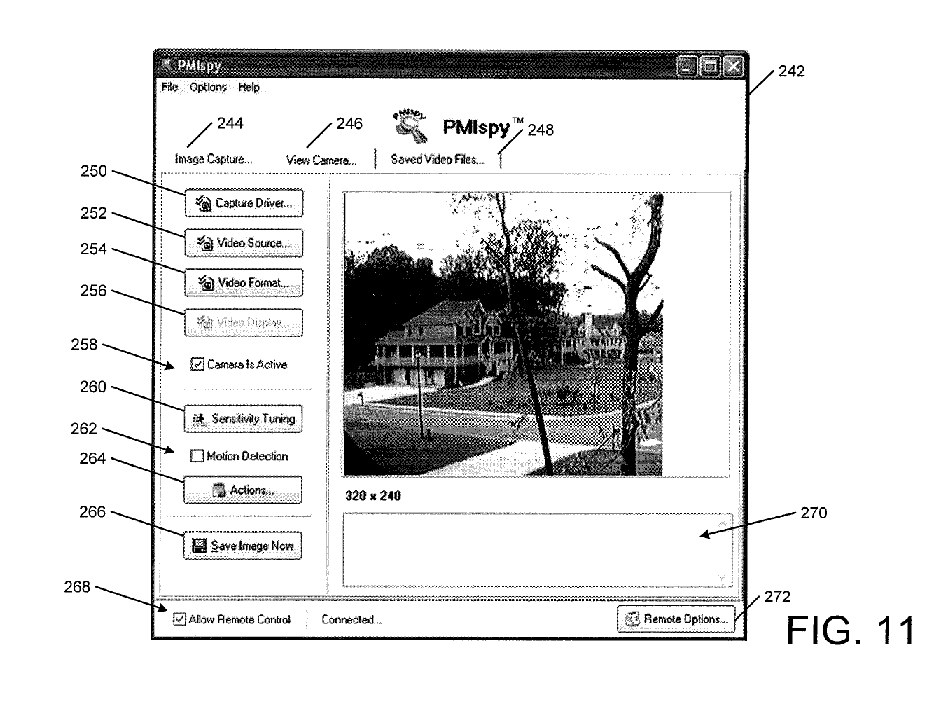

FIG. 11 is an exemplary embodiment of a user interface for monitoring an environment, similar to the user interface from FIG. 10.

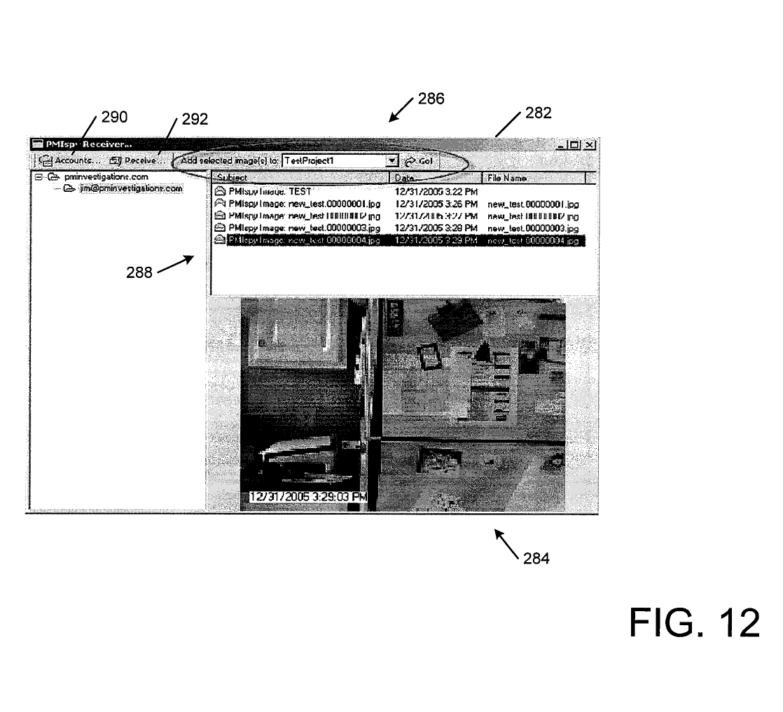

FIG. 12 is an exemplary embodiment of a user interface for capturing an image, similar to the interface from FIG. 11.

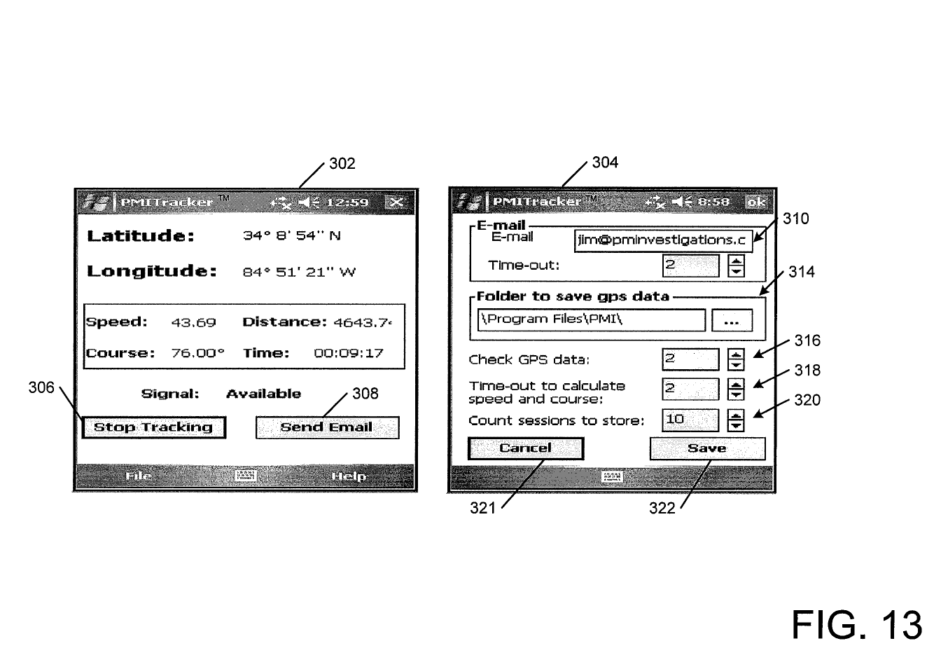

FIG. 13 is an exemplary embodiment of user interface that may be utilized in tracking the position of a device, similar to the user interface from FIG. 12.

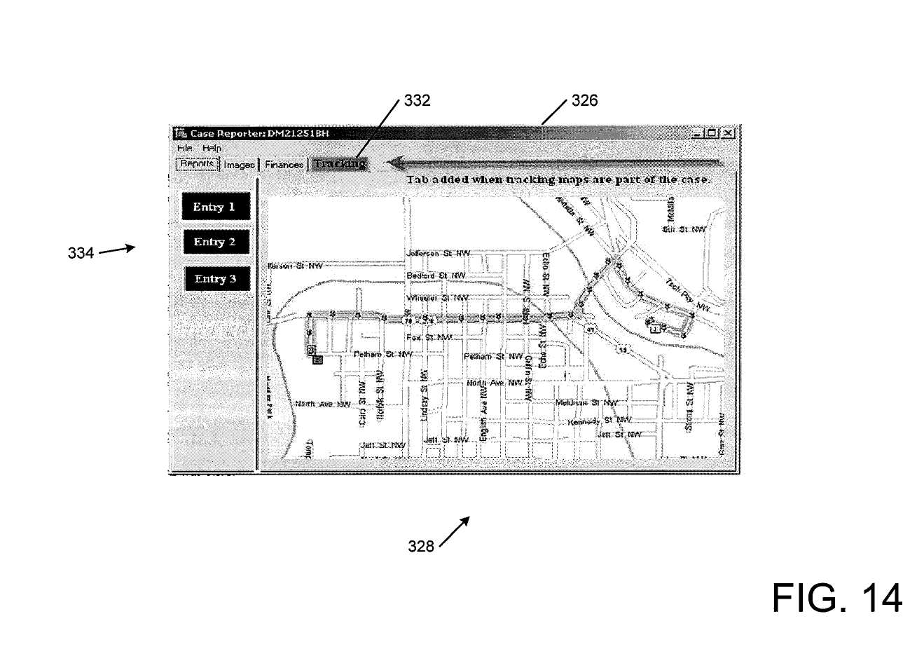

FIG. 14 is an exemplary embodiment of a user interface that may be utilized for displaying movement of a target and/or investigator, similar to the user interfaces from FIG. 13.

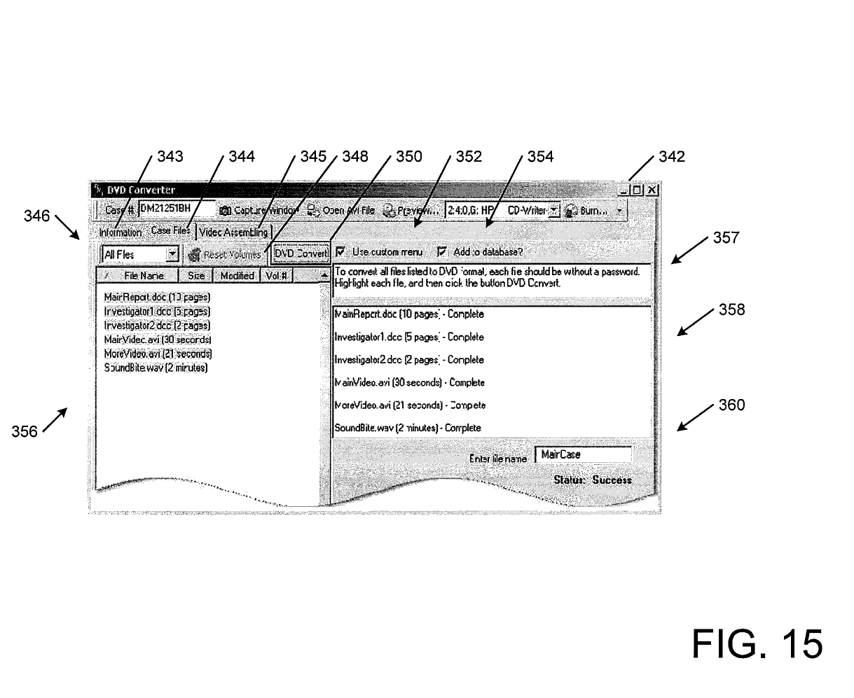

FIG. 15 is an exemplary embodiment of a user interface that may be utilized for viewing case files, similar to the user interface from FIG. 14.

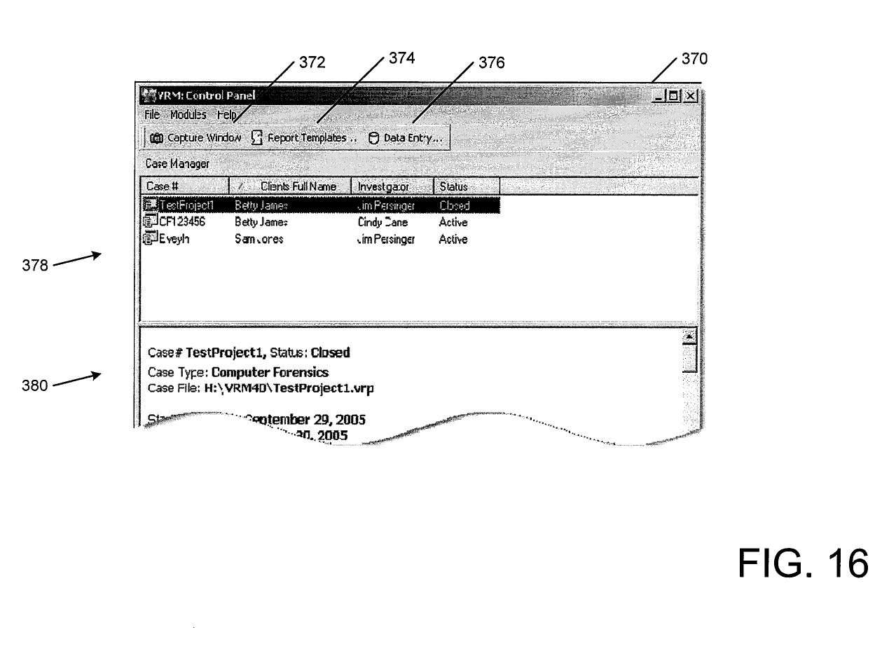

FIG. 16 is an exemplary embodiment of a user interface displaying a control panel that may be configured for changing one or more configuration parameter associated with a case, similar to the user interface from FIG. 15.

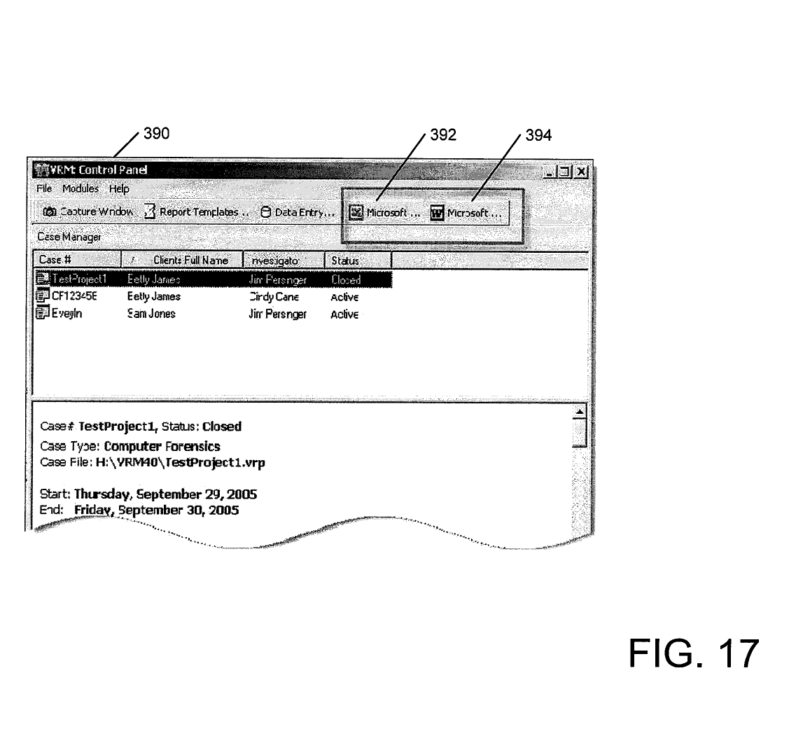

FIG. 17 is an exemplary embodiment of a user interface, illustrating a control panel, with the addition of a plurality of tabs that have been added to the interface, similar to the interface from FIG. 16.

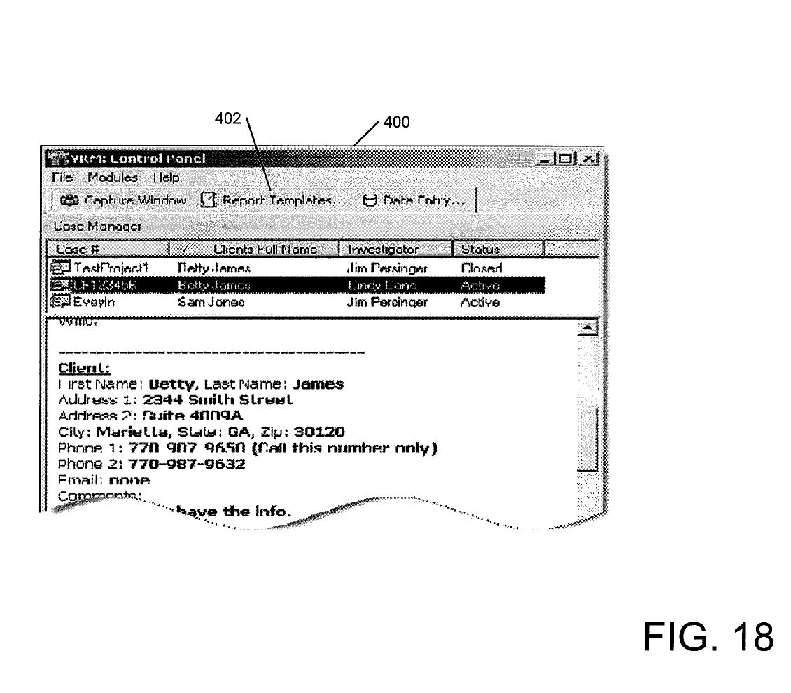

FIG. 18 is an exemplary embodiment of a user interface that may be configured to facilitate the use of templates, similar the interface from FIG. 17.

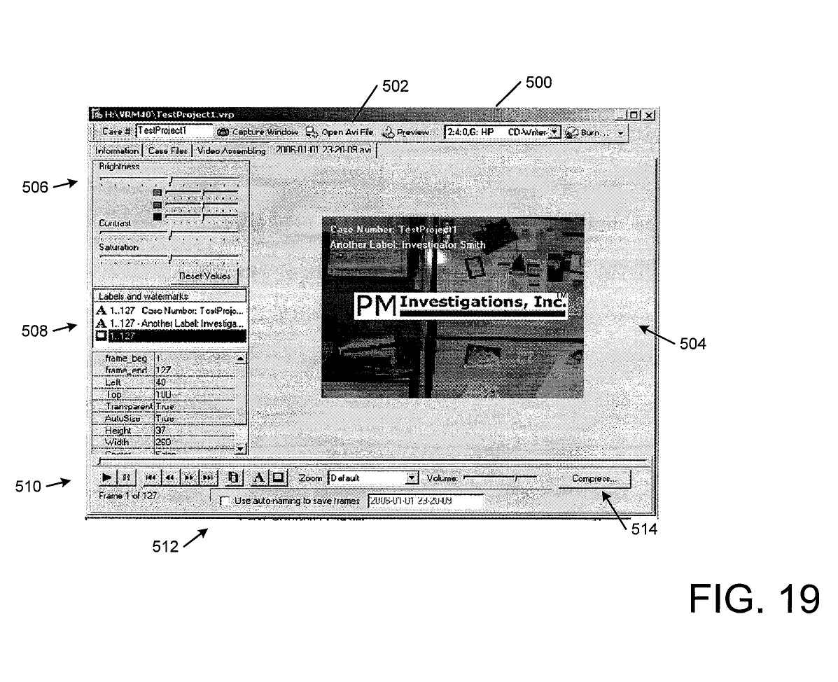

FIG. 19 is an exemplary embodiment of a user interface that may be utilized for video manipulation, similar to the interface from FIG. 18.

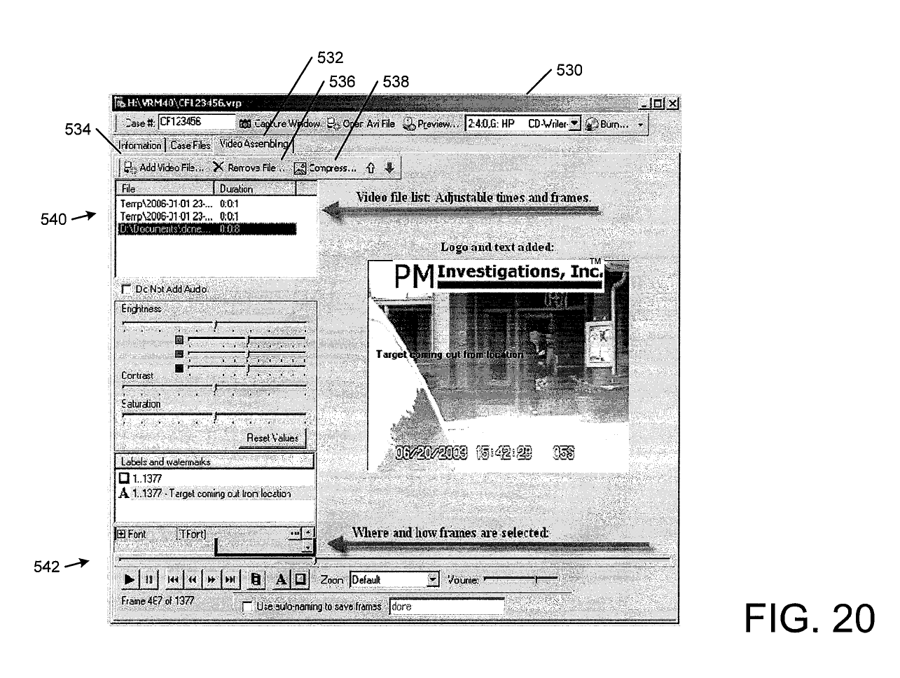

FIG. 20 is an exemplary embodiment of a user interface 530 that may be configured for advanced video assembling, similar to the interface 500 from FIG. 19.

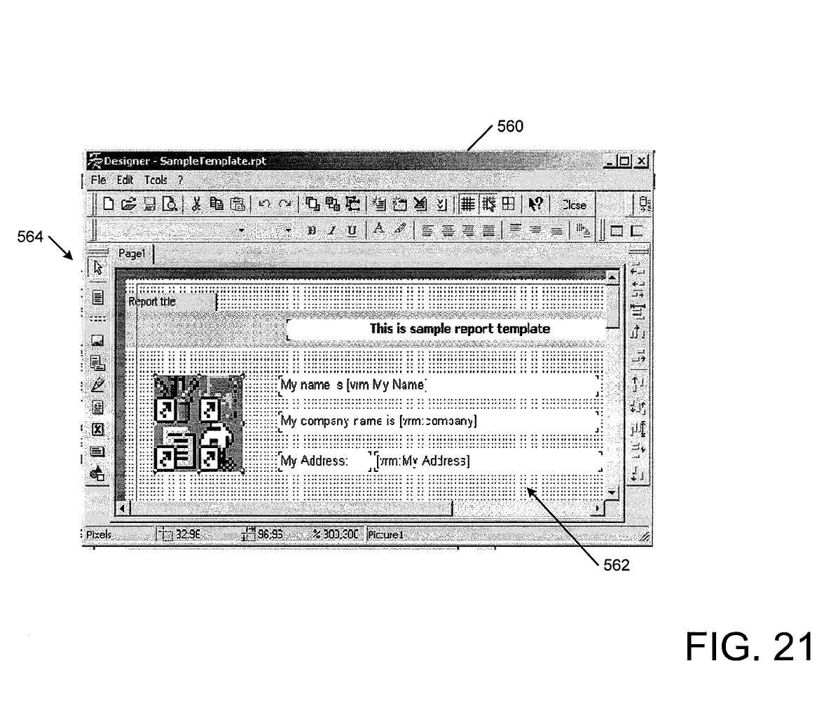

FIG. 21 is an exemplary embodiment of a user interface that may be utilized for creating and/or amending a template, similar to the user interface from FIG. 20.

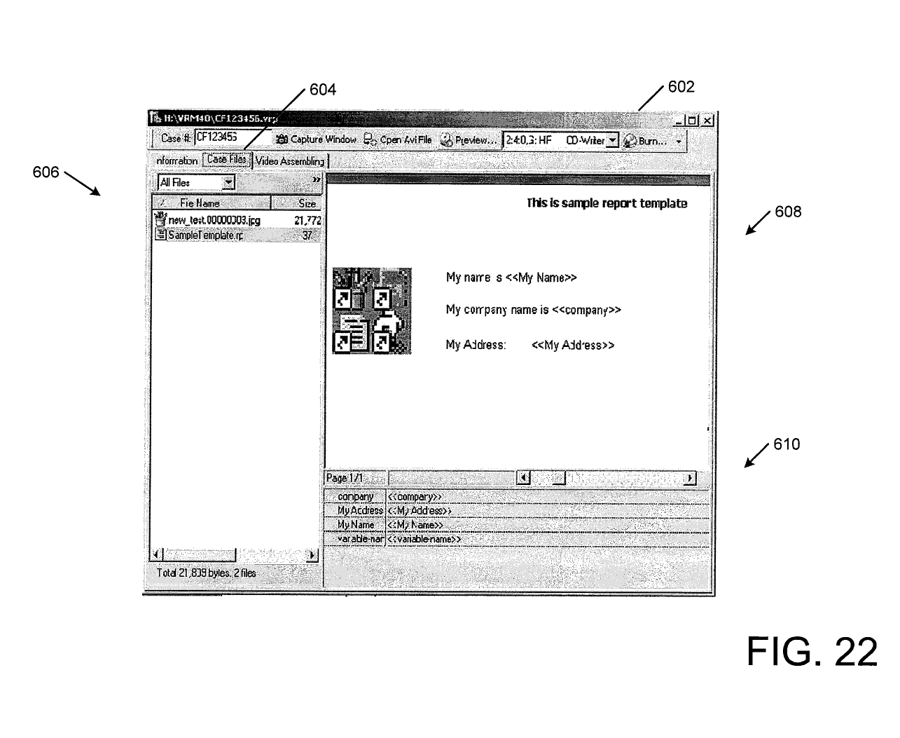

FIG. 22 is an exemplary embodiment of a user interface that may be configured to display a template as a report file, similar to the template from FIG. 21.

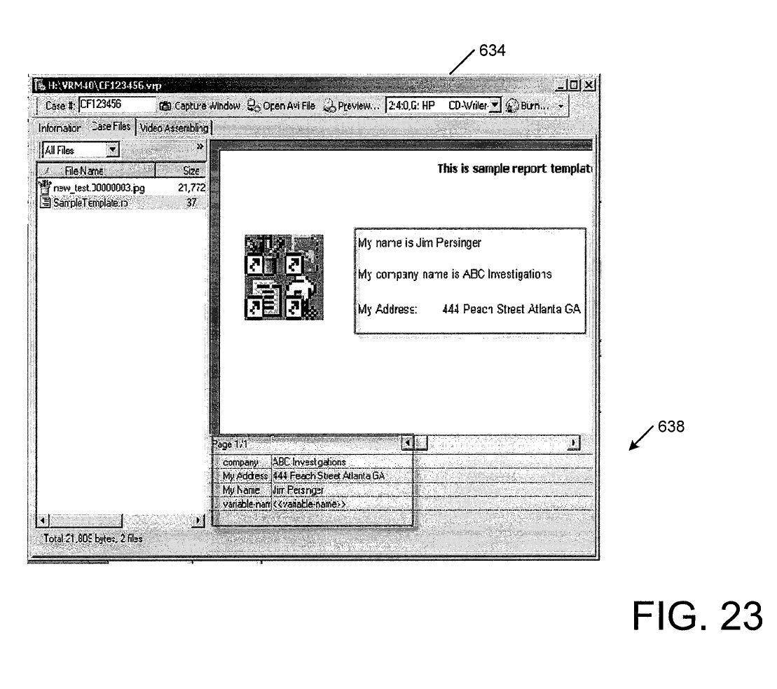

FIG. 23 is an exemplary embodiment of a user interface that may be configured to display a customized report via utilization of a template, such as the template from FIG. 22.

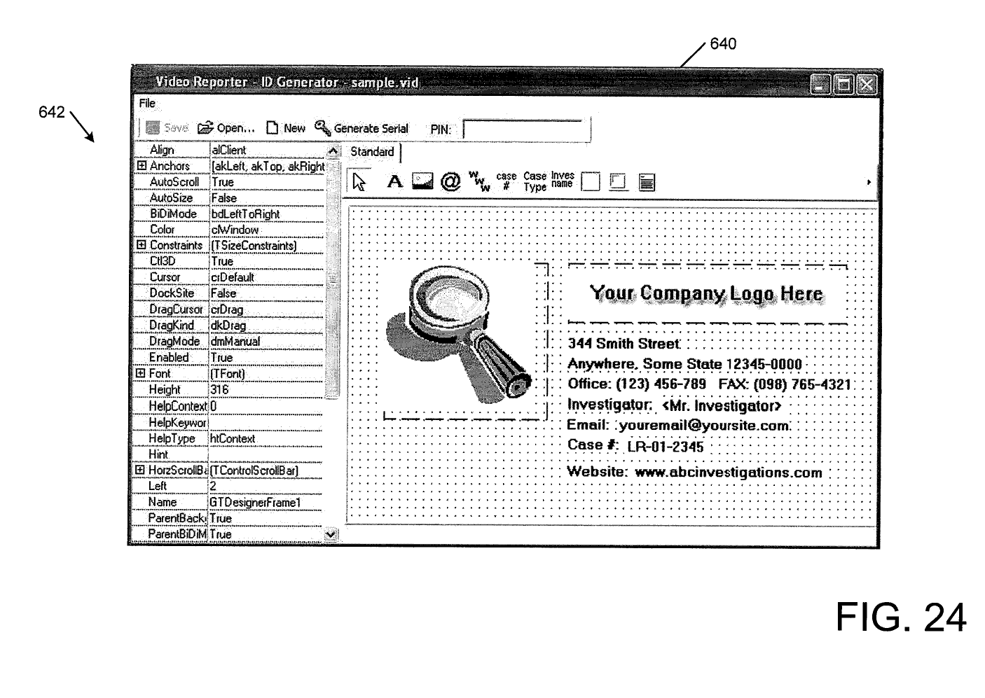

FIG. 24 is an exemplary embodiment of a user interface that may be utilized in creation of an identity file, similar to the interface from FIG. 23.

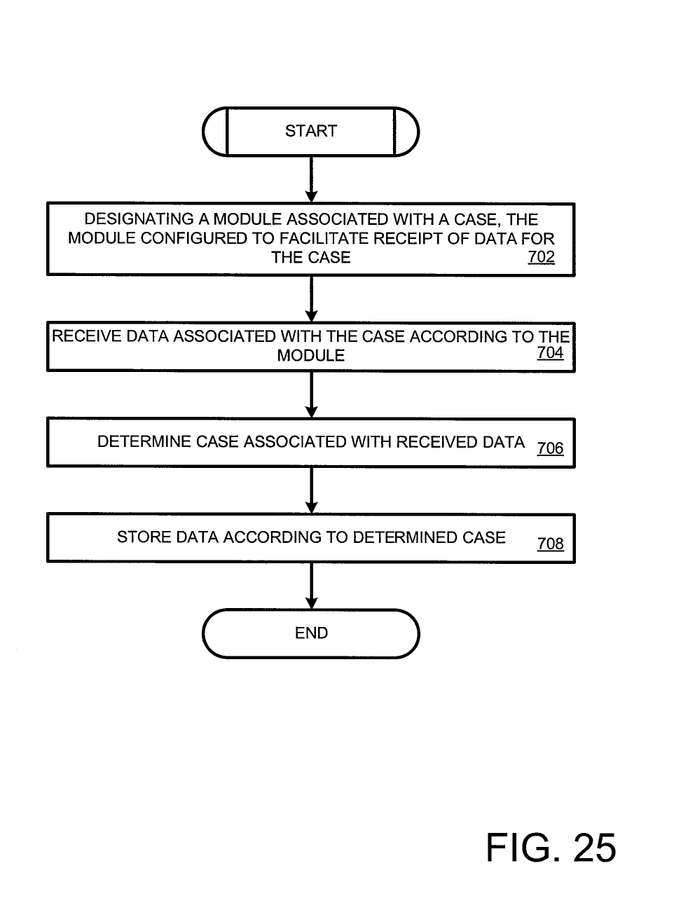

FIG. 25 is an exemplary embodiment of a process that may be utilized in storing data associated with a desired case, such as in the network from FIG. 1.

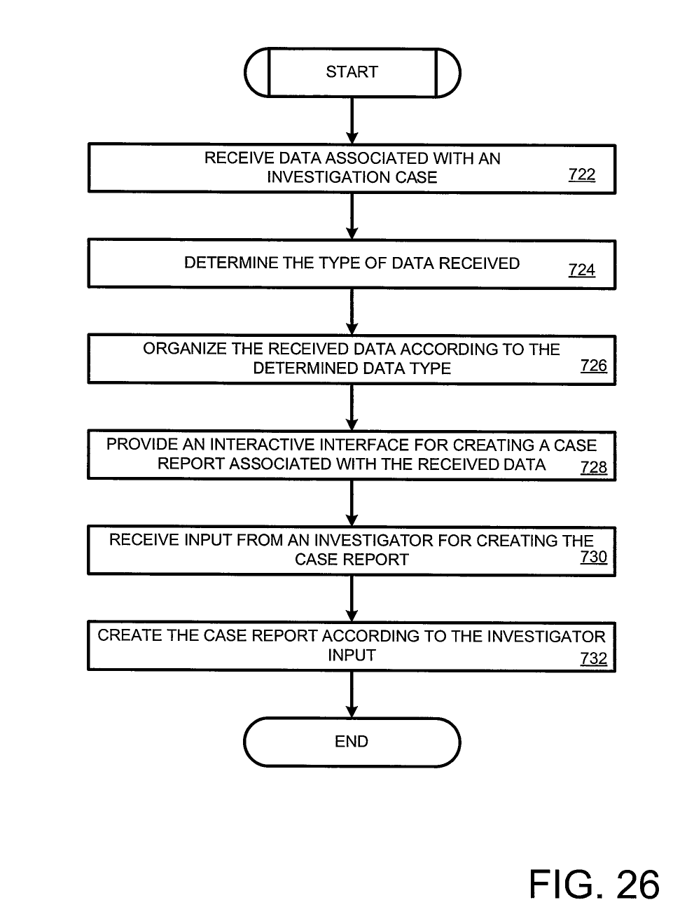

FIG. 26 is an exemplary embodiment of a process that may be utilized in creating a case report, similar to the process from FIG. 25.

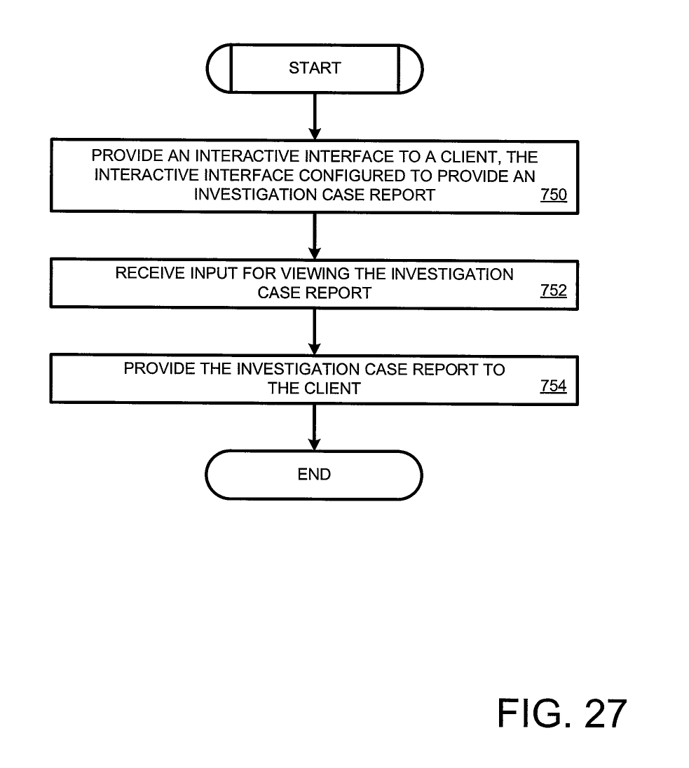

FIG. 27 is an exemplary embodiment for providing an investigation case report to a client, similar to the process from FIG. 26.

### DETAILED DESCRIPTION

Embodiments of this disclosure include systems and/or methods that may be configured to receive data from a plurality of sources. More specifically, in an exemplary embodiment, a client may contact an investigator to compile data. The investigator may record audio, video, image data, take notes, etc. Upon compiling the data, the investigator may store this data on a computing device. The investigator may then send at least a portion of this data to the client. The client may present the received information at a trial or otherwise publicly display the received data.

As a nonlimiting example, audio, image, video, textual, and/or other data may be compiled and received at a computing device. The data may be received via a network, such as the Internet, a Cellular Mobile Radio (CMR) network, a PSTN, a Local Area Network, and/or communication medium. The communication medium may be configured for wired and/or wireless communications. Similarly, the data may be locally uploaded from a storage medium, such as a Compact Disc (CD), DVD, zip drive, and/or other storage medium. The data may be received via input devices such as a keyboard, mouse, etc. Upon receiving the desired data at the computing device, the computing device may be configured to execute integrated investigation logic to facilitate compilation, organization, and presentation of the received data.

With regard to the drawings, FIG. 1 is an exemplary network configuration, illustrating a plurality of elements that may be utilized in facilitating an integrated investigation. More specifically, a computing device 4 may be coupled to a network 2. The network 2 may include the Internet, a Public Switched Telephone Network (PSTN), a Cellular Mobile Radio (CMR) network, a Local Area Network (LAN) and/or other networks. Also coupled to the network 2 are wireless access points 6a, 6b. The access points 6a, 6b may be embodied as a Wireless Fidelity (Wi-Fi) access points, however this is a nonlimiting example. In some exemplary embodiments, one or more of the access points 6a, 6b may include cellular towers. Additionally, in at least one exemplary embodiment, access points 6a, 6b may be configured to facilitate Wi-Max communications. Other embodiments are also contemplated.

Regardless of the protocol of communication, the access points 6a, 6b may be configured to facilitate communications among the computing device 4, an image capture device 12, a mobile communications device 8, and/or a server 14. As a nonlimiting example, the mobile communications device 8 may be configured to capture audio, video, image, text, global positioning data, and/or other data associated with an investigation. The mobile communications device may also be configured to store the captured data and send the captured data to the computing device 4. The data may be sent via a text message (e.g., Short Message Service (SMS)), email, instant message, and/or other delivery mediums. Additionally, depending on the particular embodiment, the computing device 4 may be configured to control at least a portion of the operations of the mobile communications device 8, such as data capture (e.g., image capture, global location, video capture, audio capture, etc.), data transmission, etc.

Similarly, the image capture device 12 may include a camera (image and/or video), a Global Positioning System (GPS) receiver, a MEMS accelerometer that detects movement or falls of the device, a Secure Digital (SD) card, and/or other components. Similar to the mobile communications device 8, the image capture device 12 may be configured to send data to and receive data from one or more of the other network elements of FIG. 1.

The server 14 may also be configured to communicate with the computing device 4, the mobile communications device 8, and/or the image capture device 12. As a nonlimiting example, in at least one exemplary embodiment, the server 14 may be configured to receive data from the computing device 4 for storage. Additionally, depending on the particular configuration, the server may be configured to send and/or receive data directly from the image capture device 12 and/or the mobile communications device 8.

In operation, the mobile communications device 8 and/or the image capture device 12 may send data to the computing device 4 via the network 2. The computing device 4 may be configured to execute one or more applications associated with an investigation. The one or more applications may be configured to facilitate creation and compilation of an integrated investigation case, as discussed in more detail, below. The created integrated investigation case may be then sent to a portable storage medium, emailed to another computing device, and/or stored at the server 14.

One should note that the image capture device 12 and the mobile communications device 8 are nonlimiting examples of data capture devices. More specifically, any device configured to capture data associated with an investigation may be utilized. Additionally, while the embodiment of FIG. 1 illustrated data capture devices as being configured to automatically send data to the computing device 4, this is also a nonlimiting example, as some embodiments may be configured for other modes of operation. Further other data capture devices may be utilized, including, but not limited to positioning devices, personal digital assistants, cellular telephones, iPods®, etc. One should also note that while the computing device 4 is illustrated as being operated by an investigator, the computing device may (depending on the particular embodiment) be utilized by a client.

FIG. 2 is an exemplary embodiment of a plurality of components that may be utilized in a computing device, such as the computing device 4, from FIG. 1. Although a wire-line communications device is illustrated, this discussion can be applied to wireless devices, as well. Generally, in terms of hardware architecture, as shown in FIG. 2, the computing device 4 includes a processor 82, memory component 84, a display interface 94, data storage 95, one or more input and/or output (I/O) device interface(s) 96, and/or one or more network interfaces 98 that are communicatively coupled via a local interface 92. The local interface 92 can include, for example but not limited to, one or more buses and/or other wired or wireless connections. The local interface 92 may have additional elements, which are omitted for simplicity, such as controllers, buffers (caches), drivers, repeaters, and receivers to enable communications. Further, the local interface 92 may include address, control, and/or data connections to enable appropriate communications among the aforementioned components. The processor 82 may be a device for executing software, particularly software stored in the memory component 84. The processor 82 can include any custom made or commercially available processor, a central processing unit (CPU), an auxiliary processor among several processors associated with the computing device 4, a semiconductor based microprocessor (in the form of a microchip or chip set), a macroprocessor, and/or generally any device for executing software instructions.

The memory component 84 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory component 84 may incorporate electronic, magnetic, optical, and/or other types of storage media. One should note that the memory component 84 can have a distributed architecture (where various components are situated remote from one another), but can be accessed by the processor 82.

The software in the memory component 84 may include one or more separate programs, which may include an ordered listing of executable instructions for implementing logical functions. In the example of FIG. 2, the software in the memory component 84 may include integrated investigation logic 99, as well as an operating system 86. The operating system 86 may be configured to control the execution of other computer programs and provides scheduling, input-output control, file and data management, memory management, and communication control and related services. Additionally, the integrated investigation logic may include a visual report manager application, and/or other applications, as described in more detail, below.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 84, so as to operate properly in connection with the operating system 86.

The Input/Output devices that may be coupled to system I/O Interface(s) 96 may include input devices, for example but not limited to, a keyboard, mouse, scanner, touch screen, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

According to exemplary embodiments, the computing device includes one or more network interfaces 98 for facilitating communication with one or more other devices. More specifically, the network interface 98 may include any component configured to facilitate a connection with another device. While in some embodiments, among others, the computing device 4 can include a network interface 98 that includes a Personal Computer Memory Card International Association (PCMCIA) card (also abbreviated as “PC card”) for receiving a wireless network card, other configurations can include the communications hardware within the computing device 4, such that a wireless network card is unnecessary for communicating wirelessly. Similarly, other embodiments include network interfaces 98 for communicating via a wired connection. Such interfaces may be configured with Universal Serial Bus (USB) interfaces, serial ports, and/or other interfaces.

If computing device 4 includes a personal computer, workstation, or the like, the software in the memory component 84 may further include a basic input output system (BIOS) (omitted for simplicity). The BIOS is a set of software routines that initialize and test hardware at startup, start the operating system 86, and support the transfer of data among the hardware devices. The BIOS is stored in ROM so that the BIOS can be executed when the computing device 4 is activated.

When the computing device 4 is in operation, the processor 82 may be configured to execute software stored within the memory component 84, to communicate data to and from the memory component 84, and to generally control operations of the computing device 4 pursuant to the software. Software in the memory component 84, in whole or in part, may be read by the processor 82, perhaps buffered within the processor 82, and then executed.

One should note that while the description with respect to FIG. 2 includes a computing device 4 as a single component, this is a nonlimiting example. More specifically, in at least one embodiment computing device 4 can include a plurality of servers, personal computers, and/or other devices. Similarly, while the description of FIG. 2 describes a computing device 4, this is also a nonlimiting example, as other components, such as the access points 6a, 6b, the mobile communications device 8, the image capture device 12, and/or the server 14 may (depending on the particular configuration) be included in the discussion of FIG. 2.

Additionally, while integrated investigation logic 99 is illustrated in FIG. 2 as a single software component, this is also a nonlimiting example. In at least one embodiment, the integrated investigation logic 99 may include one or more components, embodied in software, hardware, and/or firmware. Additionally, while integrated investigation logic 99 is depicted as residing on a single computing device, such as computing device 4, integrated investigation logic 99 may include one or more components residing on one or more different devices.

The embodiments disclosed herein can be implemented in hardware, software, firmware, or a combination thereof. At least one embodiment disclosed herein is implemented in software and/or firmware that is stored in memory and that is executed by a suitable instruction execution system. If implemented in hardware, as in an alternative embodiment, embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As discussed above, the visual report manager is a case management application that may be configured to setup data for a case in an expedited manner. In addition, the visual report manager (which may be included with the integrated investigation logic 99) may be configured with built-in intelligence to manage images, videos, reports, financial, and other related data. Once the case is ready for delivery or archiving, visual report manager may be configured to upload the data to a portable storage medium (or other storage medium) with an identity file that matches the company or employee. In at least one embodiment, the identity file can be altered, as needed.

Video, images, reports, and other data can be input into the visual report manager while never leaving the application. Videos can be compressed to smaller sizes and not affect playback. Images can be added and stored in a case folder for better organization and reports can be either written within the application or can be dragged and dropped into the case folder, allowing the Investigator to continue to use his/her favorite tools (e.g., Microsoft® Word and Coral® Word Perfect). The visual report manager may include an expense-reporting tool to add copies of the financial information related to the case within visual report manager without the need of outside accounting logic. However, the investigator can continue to use the a plurality of applications by exporting the data into an Excel Spreadsheet (e.g., naming the file “expenses.xls”) and visual report manager can display a link to the file under a Financial Tab (see below and FIG. 3).

Additionally, in at least one embodiment, the visual report manager can be installed within minutes without the need of a Database Administrator (DBA). Additionally, one or more templates (e.g., rich text format (RTF) templates) may be utilized, which can be modified to fit the desire of each user.

Additionally, a data entry section can be set up quickly by adding clients, attorney(s), investigator(s), and rates into the visual report manager with little or no instruction. Since embodiments disclosed herein do not require the field length of each area to be measured, the Investigator can type as many characters as he/she feels is needed to understand the contents.

Again referencing the drawings, FIG. 3 is an exemplary embodiment of a user interface that may be provided to an investigator in configuring an integrated investigation case, such as described with reference to FIG. 2. As illustrated in the nonlimiting example of FIG. 3, the investigator may execute an application, such as may be provided by the integrated investigation logic 99. Upon executing the application, a user interface 108 may be presented. The user interface 108 may include a plurality of options for creating an integrated investigation case. In at least one exemplary embodiment, the investigator can select (and/or create) an identity file from identity file option 136. The identity file may be configured to identify a desired investigation and/or client. The identity file may be created using proprietary methods and software tools that make the identity file useful only to this application. This identity file may include a client's information, including company name, logo, address, etc., as well as other information related to the present investigation and restricts the use of the application to the licensed individual or companies since the identity file contains data that matches the license holder information only. When the upload (e.g., burn process) is complete, the identity file gets uploaded (e.g., burned) as a wrapper to the contents on the CD or DVD or other media that allows a visual effects displaying the investigator's company logo, address, and other related information when inserted into a computer, DVD player, CD player, etc.

Additionally, as illustrated in FIG. 3, other options may be provided to the investigator. As a nonlimiting example, interface 108 may include an information tab 112. The information tab 112 may be configured to provide a plurality of options associated with the current case. More specifically, as illustrated in FIG. 3, the information tab may be configured to provide access to a case objective option. By selecting the case objective option, the investigator may be provided with a text prompt to input one or more objectives for the present investigation. Similarly, an investigation notes option is provided, as well as a client option, a finances option, a CD title option, a burn history option, and an expenses option.

Under the client option, the investigator may be provided with the option of adding one or more targets. The targets may be people, places, and/or things to be investigated. By selecting the target option, a prompt may be presented to provide the investigator the ability to enter data associated with the selected target. This information may include name, contact information (e.g., address, telephone number, email address, etc.), current location information, family members, and/or other information for locating the target. An other cases option may provide the investigator the option to select a target from another case. Also included with the client option is an attorney option. The attorney option may provide a prompt for information associated with attorneys (if applicable) involved in the current investigation. The investigator option may provide a prompt for information associated with an investigator involved in the current investigation.

Included with the finances option is a payments option, which may be configured to receive documentation associated with payments that the client has made for the present case. An hours option may be provided to document the number of hours the investigator has spent on the case. A mileage option may be configured to receive data associated with the number of miles the investigator has traveled in association with the case. An expenses option may be configured to receive a value (and/or description) of expenses incurred by the investigator for the case.

Similarly, the CD title option may be configured to receive a title of the portable storage medium. The burn history can include a log indicating a history uploading data for the case to a portable storage medium, and/or other destination.

Additionally included is a case files option 114, which may be configured to display one or more files (audio, video, image, text, Hypertext Markup Language (HTML), etc.) associated with the current investigation. A video assembling option 116 may be configured to play and/or manipulate video associated with the current investigation.

Additionally included in the nonlimiting example of FIG. 3 is a text prompt 124, which may be configured to provide quick access to other cases. More specifically, by entering a case number in text prompt 124, an investigator may be granted access to other cases. Similarly, capture window option 126 may be configured to facilitate capture of video on the fly before adding the video to the current investigation. This gives the investigator the ability to review the file before adding it to the current case. As the investigator then views the video, and selected frames can be extracted from that video which can later be added to any case file. An open avi file option 128 may be configured to open a video file (of avi video format and/or other format). A preview option 130 may be configured to preview the data displayed in display window 110. An option 132 may be configured to select a destination to upload at least a portion of the case data. A burn option may be selected to execute an upload of at least a portion of the case data.

FIG. 4 is an exemplary embodiment of a user interface 142 of client information that may be presented to a client, such as may be created by the integration investigation logic 99 from FIG. 2. As illustrated in the nonlimiting example of FIG. 4, upon receiving the complied data from the investigator, the user may access the received data via the interface 142. The interface 142 may include a welcome tab 144, which may be configured to display the client data discussed with regard to FIG. 3. Additionally, other data may be provided via additional tabs, such as a finances tab 146.

More specifically, depending on the particular data received by the investigator, the visual report manager may be configured to automatically create tabs associated with the data received. Referring to FIG. 4, because the data includes the client information, the welcome tab 144 is created. Additionally, as financial information is included, a finances tab 146 is also created. While not explicitly illustrated in FIG. 4, if other data is provided, (e.g., pictures, videos, etc.), tabs may be created for that data, as well.

One should note that while the description with regard to FIG. 4 illustrates an interface provided to a client, this is a nonlimiting example. More specifically, in at least one exemplary embodiment, the investigator may be provided with this (or a similar) interface for ensuring accuracy in the data provided to the client.

FIG. 5 is an exemplary embodiment of a user interface 152 that includes client data, similar to the interface from FIG. 3. As illustrated in the nonlimiting example of FIG. 5, the user interface 152 is similar to the user interface 108 from FIG. 3, with different client data. More specifically, by selecting a different identity file in option 154, an investigator can facilitate display of different data in display area 156.

FIG. 6 is an exemplary embodiment of a user interface 162 that includes amended client data, similar to the interface from FIG. 4. As illustrated in the nonlimiting example of FIG. 6, by changing the identity file in option 154 (FIG. 5), a different display is provided to the user and/or investigator.

As discussed above, tab control relates to what is shown in the product provided to the user. When images are added, but reports and video are not, the displayed tab in user interface 162 may include only an images tab. The other potential tabs may be “turned off” and/or invisible to the client. This gives the client the look and feel of a complete case, instead of certain areas being empty. This task may be performed automatically without the aid of the investigator.

As a nonlimiting example, with regard to the drawings, FIG. 7 is an exemplary embodiment of a user interface 168 that includes one or more images associated to a case, similar to the interface from FIG. 6. As illustrated, the user interface 168 may include an images tab 169, when images 170 have been associated with the selected case. The images 170 may be presented to the client (and/or investigator) via a preview option 172. Additionally, an image may be printed via a print image option 174. Thumbnails may be viewed and/or generated via a thumbnails option 176. The image may be zoomed via a zoom option 178. The image may be displayed in area 180.

FIG. 8 is an exemplary embodiment of a user interface 192 for displaying video and/or audio, similar to the interface from FIG. 7. As illustrated in the nonlimiting example of FIG. 8, the user interface 192 may be configured with a video & audio tab 194. The video & audio tab 194 may be configured for display when video and/or audio is associated with a case. Upon selection of the video & audio tab 194, options for displaying a video and/or audio may be presented. More specifically, the client (and/or investigator) can access one or more audio and/or video files that are associated with the case via an open option 196. Upon selection of the open option 196, the client (and/or investigator) may be provided an option (not shown in FIG. 8) to choose the desired file for viewing. Upon selecting the desired file, the client (and/or investigator) can play the selected file via play option 200. The client (and/or investigator) can stop the video via a stop option 202, pause via a pause option 204, rewind via a rewind option 206, and fast forward via a fast forward option 207.

Additionally included in the interface 192 is an extract frame option 208. More specifically, if the client and/or investigator desires to capture a frame of the video, he/she can select the extract frame option 208. This will automatically send the captured image to the images portion of the visual report manager, for display in an interface, such as interface 168 (FIG. 7). The client and/or investigator may also alter one or more attributes of the video and/or audio via brightness option 210, display size option 212, and volume option 214.

An issue that investigators often face after conducting fieldwork is how to add the data to the correct case, while minimizing the steps to do so. Additionally, there are times when the investigator is requested to send the data to the main office so someone else can see the data related to the case without the need of returning to the office to download the data. Further, there are times when collecting data includes allowing an apparatus and/or application to run (e.g., capturing data) for an unlimited time period.

Embodiments disclosed herein may be configured with modules for capturing data. Additionally, the visual report manger may be configured to allow flexibility to match the client's (and/or investigator's) needs. Some modules may remain portable (e.g., can be used without visual report manager), but at least one of the modules may be configured to allow the investigator to control how data gets added to the case when used with the visual report manager. The visual report manager may be configured to not only add one or more modules, but can determine how the module(s) collect data that can later be added to the correct case.

FIG. 9 is an exemplary embodiment of a user interface 222 that may facilitate addition and/or deletion of one or more data capture modules from the visual report manager, such as may be provided by the computing device 4, from FIG. 2. As illustrated in the nonlimiting example, the user interface 222, may be provided to the investigator in response to selecting an option to configure the module(s). The option may be provided in a user interface (e.g., user interface 108 from FIG. 3), however this is not a requirement. The user interface 222 may be configured with a listing of installed modules in window 224. The investigator can select (and/or deselect) the module or modules that the investigator wishes to utilize with the visual report manager. While in at least one exemplary embodiment, the selections may permeate universally to all cases, this is a nonlimiting example, as in at least one embodiment, the selection of modules may be limited to a particular case. Additionally, the user interface 222 may be configured to add (and/or delete) toolbar shortcuts associated with the one or more modules.

One should note that while two modules are illustrated in FIG. 9, in at least one exemplary embodiment, the investigator may have the option to utilize the visual report manager without use of a module. Additionally, in at least one exemplary embodiment, any number of modules may be utilized to capture, organize, and/or manipulate data associated with a case.

FIG. 10 is an exemplary embodiment of a summary billing user interface 232, which may be accessed via a summary billing module, such as displayed in FIG. 9. As illustrated in the nonlimiting example of FIG. 10, the user interface 232 may be configured to compile data for billing. As a nonlimiting example, as bills are received, mileage accrued, and/or hours logged by the investigator, the summary billing module can compile this data and present an interface for displaying this data. As shown, the user interface 232 may be configured to, in window 234, display a plurality of clients, the number of cases for each client, total expenses for each client, total tax, total payments, and current balance for each client. Additionally, by selecting one or more of the clients listed, the summary-billing module may be configured to create a report (which may act as a bill to the client) that includes at least a portion of this data. While the report may be printed and mailed to the client, saved and emailed to the client, some embodiments may be configured to automatically include this report as part of the data presented to the user, such as in user interface 142 (see FIG. 4).

FIG. 11 is an exemplary embodiment of a user interface 242 for monitoring an environment, similar to the user interface 232 from FIG. 10. As illustrated, interface 242 may be associated with a module (e.g., a PMISpy™ module) that can be configured, as described with reference to interface 222, from FIG. 9. Additionally, the interface 242 may be configured to facilitate communication with a web-enabled camera (and/or other image capture device) to monitor an environment. Depending on the particular embodiment, the image capture device 12 may be configured to send real-time images and/or video to the PMISpy™ module. The interface 242 may also be configured to facilitate image capture via image capture option 244. A user can view information related to the camera that is capturing the data via a view camera option 246. Previously stored data may be viewed via selection of a saved video files option 248.

Also included with embodiments of interface 242 is a capture driver option 250, which may be configured to capture drivers that may be utilized in viewing and/or manipulating the received data. A video source option 252 may be configured to provide the investigator with an option to view and/or change the source of data that is being captured. As a nonlimiting example, in at least one exemplary embodiment, the investigator may be provided the option to view the data captured from a different camera than is currently being displayed. A video format option 254 may also be included, as well as a video display option 256 to begin display of a video.

Camera option 258 may be selected to activate or deactivate a camera. A sensitivity tuning option 260 and a motion detection option 262 may be utilized for motion-activated recording. An actions option 264 may also be utilized to determine the actions that activate the camera, when the motion detection option 262 is selected. A save image now option 266 may be selected to save an image to the images section, described above.

Also included with the user interface is an allow remote control option 268, and a remote options option 272. These options may be utilized to provide remote control of the camera. A text area 270 may be utilized to inform the investigator of the current actions that are occurring.

FIG. 12 is an exemplary embodiment of a user interface 282 for capturing an image, similar to the interface 242 from FIG. 11. As illustrated in the nonlimiting example of FIG. 12, the user interface 282 may be configured to facilitate storage and/or organization of images captured from the camera described with regard to FIG. 11. More specifically, by selecting the save image now option 266, from FIG. 11, the interface 282 may be displayed. The interface 282 may include a display window 284 for displaying the captured image. Additionally, the interface 282 may include a case option 286 for selecting a desired case and/or folder for storing the image. A window 288 may be utilized for providing one or more options for storing the image. An accounts option 290 may be utilized for selecting an account for storing the image. A receive option 292 may be configured to provide the investigator the ability to receive data from one or more different sources.

Additionally, other modules and/or interfaces may be utilized and considered part of the present disclosure. At least one module may include a Palm/Pocket PC Syncing for case mobility, which allows case information to be passed back to the main location where the data is stored (e.g., investigator's main office computer). Another module may include a data backup or password module. The data backup or password module may be configured to automatically back up and/or protecting received data. Another module may include a time tracker and announcer with spell checker. This module may be configured to log each time an investigator opens a case and/or makes a change to a case. When a case folder is opened, a timer may be started. When the case folder is closed, the timer automatically stops. The billable time may be placed in the financial area of Visual Report Manager. Another module may include a spell checker. Yet another module may include an International Standards Organization (ISO) reader. More specifically, when a case has been archived, ISO reader may be configured to reformat the file to be readable again, and allows the investigator to upload the case again, if desired.

Referring again to the drawings, FIG. 13 is an exemplary embodiment of user interfaces 302, 304 that may be utilized in tracking the position of a device, similar to the user interface 282 from FIG. 12. As illustrated, the user interfaces 302, 304 may include a PMItracker™ module that may be configured to collect information such as latitude, longitude, speed, distance and field time of an image capture device 12, a mobile communications device 8, and/or other device. This information can then be passed back to the Visual Report Manager, which may be configured to convert the raw positioning data into a map. The investigator can elect to use custom maps that later can be added to the final product.

As a nonlimiting example, the investigator may place a camera in an environment for monitoring a target. The camera may be equipped with a positioning system that is activated upon the device being moved. Upon detecting this movement, the camera can send positioning data at predetermined times, regular intervals, when the movement stops, and/or at other times. As the data is being sent from the camera to the integrated investigation logic 99, the investigator may be provided with interface 302 and/or interface 304. Interface 302 may be configured to provide global positioning data of the camera (or other device), including latitude, longitude, speed, course, distance traveled, and time traveled. Also included in the interface 302 is a stop tracking option 306 (which, depending on the particular embodiment, may change to a begin tracking option when tracking is deactivated). The interface 302 may also include a send email option 308, which may email the displayed data to one or more predetermined email addresses.

The interface 304 may be configured to provide the investigator with an option 310 to designate the email address associated with the send email option 308. A folder option 314 may be configured to designate a folder to send the captured positioning data. A check GPS data option 316 may be configured to designate a time period between positioning checks. Time-out option 318 may be configured to determine a time-out for calculating speed and/or course. A count sessions option 320 may be configured to determine the number of sessions to store. Also included are a cancel option 321 and a save option 322.

FIG. 14 is an exemplary embodiment of a user interface 326 that may be utilized for displaying movement of a target and/or investigator, similar to the user interfaces 302, 304 from FIG. 13. As illustrated, upon receipt of the positioning data, the integrated investigation logic 99 may be configured to associate this data with a map for display to the investigator and/or client. The user interface 326 may include a display portion 328 for displaying visual depiction of the location data received. Additionally, when utilizing the tracking module, a tracking tab 332 may be included in the user interface 326. Also included are entry options 334.

FIG. 15 is an exemplary embodiment of a user interface 342 that may be utilized for viewing case files, similar to the user interface 326 from FIG. 14. As illustrated in the nonlimiting example of FIG. 15, the user interface 342 may be displayed to an investigator and may include an information tab 343, a case files tab 344, and a video assembling tab 345. Under the case files tab, an all files option 346 may be configured to provide the investigator with one or more options of displaying files of a predetermined classification in a window 356. The classification window may include a file name, size, date of last modification, volume number, and/or other data.

Also included in the interface 342 is a reset volumes option 348, which may be utilized for resetting volumes of audio and/or video data. A DVD convert option 350 may be selected for converting captured data into a format for burning onto a DVD. A custom menu option 352 may be selected for utilizing a custom menu. An add to database option 354 may be selected to add data to a database. Also included are an instruction window 357, a log window 358, and a file name prompt 360.

FIG. 16 is an exemplary embodiment of a user interface 370 displaying a control panel that may be configured for changing one or more configuration parameter associated with a case, similar to the user interface 342 from FIG. 15. As illustrated in the nonlimiting example of FIG. 16, the user interface 370 may include a capture window option 372, which may be configured for capturing data from a window for storage. Report templates may also be included and may be configured to open one or more report templates. A data entry option 376 may be included and may provide options related to data entry.

Also included in the exemplary embodiment of user interface 370 is a case window 378, which may be configured to display one or more cases, client name, investigator, and/or current status of the case. Other information may also be included. A details window 380 may also be included for displaying details of a selected case.

FIG. 17 is an exemplary embodiment of a user interface 390, illustrating a control panel, with the addition of a plurality of tabs 392, 394 that have been added, similar to the interface 370 from FIG. 16. As illustrated in the nonlimiting example of FIG. 17, the interface 392 may be the same interface as illustrated in FIG. 16. At least one difference in the embodiment of FIG. 17 is that the investigator may have exercised an option to add one or more options 392, 394 to a toolbar of the interface 392. More specifically, although currently running the visual report manager, the investigator may have the option to create toolbar buttons for accessing other programs stored on the computing device 4. Selection of one or more of the options 392, 394 may launch a first program within the interface of the visual report manager, however this is not a requirement.

FIG. 18 is an exemplary embodiment of a user interface 400 that may be configured to facilitate the use of templates, similar to the interface 390 from FIG. 17. As illustrated in the nonlimiting example of FIG. 18, the user interface 400 may be the same as the user interface 390, from FIG. 17, however this is not a requirement. Additionally, by selecting a report templates option 402, the investigator may be provided with one or more templates for facilitating data input for one or more cases. Additionally, the investigator can edit the templates inside any text editing application. The investigator can also remove fields from a template without affecting the performance of the application.

FIG. 19 is an exemplary embodiment of a user interface 500 that may be utilized for video manipulation, similar to the interface 400 from FIG. 18. As illustrated in the nonlimiting example of FIG. 19, the interface 500 may include an open avi file option 502. By selecting this option, the investigator may be provided with a video (avi and/or other format) in video window 504. The interface 500 may also provide value change options 506, labels and watermarks options 508, trick mode functionality and other options 510 (e.g., play, pause, skip back, rewind, fast forward, skip forward, text insert, zoom, volume, and/or other options). Additionally included are an auto-naming option 512, and a compress option 514, which may be configured to compress the selected video file.

With the interface 500, the investigator can extract frames and each one can be automatically placed in the correct case folder. Additionally, the investigator can add text labels that can be font adjustable and frame selectable. The investigator can add image watermarks that may be moveable and frame selectable. The investigator may also remove the audio by utilization of the video assembling section.

FIG. 20 is an exemplary embodiment of a user interface 530 that may be configured for advanced video assembling, similar to the interface 500 from FIG. 19. As illustrated in the nonlimiting example of FIG. 20, the interface 530 may include a video assembling option 532. The video assembling option 532 may be configured to provide one or more options for viewing and/or manipulating a video file. As a nonlimiting example, the investigator may be provided with an add video file option 534, a remove file option 536, and a compress option 538. Also included in the exemplary embodiment of FIG. 20 is a file window 540, which may be configured to display one or more files that may be viewed (audio, image, and/or video). The interface 530 may also include a frame selection option 542 for selecting frames to view and/or capture.

FIG. 21 is an exemplary embodiment of a user interface 560 that may be utilized for creating and/or amending a template, similar to the user interface 530 from FIG. 20. As illustrated in the nonlimiting example of FIG. 21, the user interface 560 may include a template area 562 for creating and/or editing a template. The template may be configured to provide easy reporting for an investigator, such that reports for a client and/or case are generally consistent. However, as discussed above, the one or more templates may be configured such that, if a change is desired, the investigator may amend a template within the visual report manager. The interface 560 may also include a plurality of template amendment options 564 for facilitating amendment of a template. The template generator may provide similar functionality and/or options as a word processor. However, in at least one embodiment, the template generator may be configured to provide live variables that can be changed on the fly. This incorporates the ability to change the data based on a case-by-case basis, as the information is input into the template by the investigator. Other features of this template includes adding images as logos, boxes to give the template a look and feel where the user can add text anywhere within the text box, create custom shapes like stars or circles. While in some embodiments, this template can only be viewed while using visual report manager, other embodiments are not so limited.

FIG. 22 is an exemplary embodiment of a user interface 602 that may be configured to display a template as a report file, similar to the template from FIG. 21. As illustrated in the nonlimiting example of FIG. 22, the user interface 602 may be configured to display a generated template by selecting a case files tab 604. Under this tab, one or more files associated with the selected case may be displayed in file window 606. By selecting a template from the list in file window 606, the corresponding template may be displayed in display window 608. also included is a variable window 610 for designating variable values for the selected template.

FIG. 23 is an exemplary embodiment of a user interface 634 that may be configured to display a customized report via utilization of a template, such as the template from FIG. 22. As illustrated in the nonlimiting example of FIG. 23, the investigator may enter the desired information into a variable window 638. By designating this information, the template may automatically update the variables designated. This may provide a report to the investigator that includes the customized data.

FIG. 24 is an exemplary embodiment of a user interface 640 that may be utilized in creation of an identity file, similar to the interface 634 from FIG. 23. As illustrated in the nonlimiting example of FIG. 24, the interface 640 may be utilized for creating and amending an identity file. In at least one exemplary embodiment, the identity file can designate various information related to a client. Additionally, the interface 640 may be utilized to create an identity file in a proprietary format, such that only the designated client can utilize the full capabilities of the investigation case. Additionally, the identity file may be configured to generate one or more serial numbers for registering the visual report manager.

FIG. 25 is an exemplary embodiment of a process that may be utilized in storing data associated with a desired case, such as in the network from FIG. 1. As illustrated in the nonlimiting example of FIG. 25, the visual report manager can designate a module for an investigation case, where the designated module is configured to facilitate receipt of data for the case (block 702). The visual report manager can receive data associated with the case according to parameters of the module (block 704). As discussed above, the data may be received via a camera, mobile communications device, and/or other device. As also discussed above, one or more modules may be associated with these devices. The visual report manager can then determine the investigation case that is associated with the received data (block 706). As a nonlimiting example, the device that is sending the data may be configured with logic for tagging the sent data. Similarly, in some embodiments, the visual report manager may include logic for determining the desired case. This logic may include logic for determining the source of the data (e.g., a predetermined camera is determined to be associated with a certain case), however, this is not a requirement. The visual report manager can store the data according to the determined case (block 708).

FIG. 26 is an exemplary embodiment of a process that may be utilized in creating a case report, similar to the process from FIG. 25. As illustrated in the nonlimiting example of FIG. 26, the visual report manager can receive data that is associated with an investigation case (block 722). The visual report manager can determine the type of data received (block 724). As discussed above, the data may include audio data, image data, video data, report data, and/or other types of data. The visual report manager can organize the received data according to the determined data type (block 726). The visual report manager can then provide an interactive interface for creating a case report associated with the received data (block 728). As discussed above, the interactive interface may be configured such that one or more tabs are displayed for the types of data determined. The visual report manager can receive input from an investigator for creating the case report (block 730). The visual report manager can create the case report according to the investigator input (block 732).

FIG. 27 is an exemplary embodiment for providing an investigation case report to a client, similar to the process from FIG. 26. As illustrated in the nonlimiting example of FIG. 27, an investigation report may be created and the report provided to a client. The report may be sent via a burned CD and/or DVD, however other techniques may include any transmission and/or storage medium. Upon receiving the report, the client may utilize a computing device to execute data on the transmission and/or storage medium. The computing device (with the transmission/storage medium) can provide an interactive interface that is configured to provide the investigation report (block 750). Input may be received for viewing the investigation report (block 752). The investigation may be provided to the client (block 754).

The embodiments disclosed herein can be implemented in hardware, software, firmware, or a combination thereof. At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for providing an integrated investigation, comprising:
receiving data associated with an investigation case;
organizing the received data according to the determined data type; and
providing an interactive interface for creating a case report associated with the received data, the interactive interface configured to incorporate at least one module for receiving data from a remote data capture device.

2. The method of claim 1, further comprising receiving input from an investigator for creating the case report.

3. The method of claim 1, further comprising creating the case report according to the investigation input.

4. The method of claim 1, wherein the data capture device includes at least one of the following: an image camera, a video camera, a positioning device, a cellular telephone, and a personal digital assistant.

5. The method of claim 1, wherein the at least one module includes at least one of the following: a component configured to capture data from a video camera, a component configured to receive financial data, and a component configured to receive data from a mobile device.

6. The method of claim 1, wherein the interactive interface is configured to provide a customizable toolbar, the customizable toolbar configured to provide a user option to create at least one toolbar option.

7. The method of claim 1, further comprising creating an identity file, the identity file configured to identify information related to a client.

8. A system for providing an integrated investigation, comprising:
a first receiving component configured to receive data associated with an investigation case;
an organizing component configured to organize the received data according to the determined data type; and
a providing component configured to provide an interactive interface for creating a case report associated with the received data, the interactive interface configured to incorporate at least one module for receiving data from a remote data capture device.

9. The system of claim 8, further comprising a second receiving component configured to receive input from an investigator for creating the case report.

10. The system of claim 8, further comprising a creating component configured to create the case report according to the investigation input.

11. The system of claim 8, wherein the data capture device includes at least one of the following: an image camera, a video camera, a positioning device, a cellular telephone, and a personal digital assistant.

12. The system of claim 8, wherein the at least one module includes at least one of the following: a component configured to capture data from a video camera, a component configured to receive financial data, and a component configured to receive data from a mobile device.

13. The system of claim 8, wherein the at least one module includes at least one of the following: a component configured to capture data from a video camera, a component configured to receive financial data, and a component configured to receive data from a mobile device.

14. The system of claim 8, further comprising a creating component configured to create an identity file, the identity file configured to identify information related to a client.

15. A computer readable storage medium for providing an integrated investigation, comprising:
first receiving logic configured to receive data associated with an investigation case;
organizing logic configured to organize the received data according to the determined data type; and
providing logic configured to provide an interactive interface for creating a case report associated with the received data, the interactive interface configured to incorporate at least one module for receiving data from a remote data capture device.

16. The computer readable storage medium of claim 15, further comprising second receiving component configured to receive input from an investigator for creating the case report.

17. The computer readable storage medium of claim 15, further comprising a creating logic configured to create the case report according to the investigation input.

18. The computer readable storage medium of claim 15, wherein the data capture device includes at least one of the following: an image camera, a video camera, a positioning device, a cellular telephone, and a personal digital assistant.

19. The computer readable storage medium of claim 15, wherein the at least one module includes at least one of the following: logic configured to capture data from a video camera, logic configured to receive financial data and logic configured to receive data from a mobile device.

20. The computer readable storage medium of claim 15, further comprising creating logic configured to create an identity file, the identity file configured to identify information related to a client.
